(19) United States
(12) Patent Application Publication
(10) Pub. No.: US 2008/0254698 A1
(43) Pub. Date: Oct. 16, 2008

(54) Marine Flexible Laminate System

(75) Inventors: Peter Cua Yao, Pickerington, OH (US); Alicia Pulmares Yao, Pickerington, OH (US); John M. Schirmer, Canton, MI (US)

Correspondence Address: RATNERPRESTIA, P O BOX 980, VALLEY FORGE, PA, 19482-0980, US

(73) Assignee: P.H. GLATFELTER COMPANY, York, PA (US)

(21) Appl. No.: 12/093,863

(22) PCT Filed: Nov. 16, 2006
(86) PCT No.: PCT/US2006/044459

§ 371 Date: May 15, 2008

Related U.S. Application Data
(60) Provisional application No. 60/737,368, filed on Nov. 16, 2005.

(51) Int. Cl. B32B 33/00; B32B 37/00; D04H 1/02; D04H 3/08; D03D 25/00; D04H 1/00; B32B 27/04

(52) U.S. Cl. 442/181; 156/278; 428/346; 442/368; 428/353; 442/401; 442/367; 442/365; 442/369

(57) ABSTRACT

A marine flexible laminate system at a minimum includes a primer layer and an adhesive layer. The system optionally includes at least one functional top coating layer which may be applied either underwater or before submersing. Other layers include a backing layer and a heat curing layer. The marine laminate is directly applied to one or more surfaces submerged under-water by contacting the submerged surface with the adhesive layer of the flexible marine laminate.

### CROSS REFERENCE TO RELATED APPLICATIONS

This application claims priority of U.S. Provisional Application 60/737,368 filed Nov. 16, 2005.

### FIELD OF THE INVENTION

The present invention relates to a marine flexible laminate system. In particular, the invention is directed to a marine flexible laminate that can be applied underwater. The marine flexible laminate system comprises a functional top coat layer, a primer layer, a backing layer and an adhesive layer. The marine flexible laminate system is applied to one or more surfaces submerged underwater by contacting the one or more submerged surfaces with the adhesive layer of the marine flexible laminate.

### BACKGROUND OF THE INVENTION

Marine laminates are typically constructed of a polymeric substrate sandwiched between a top layer and an adhesive lower layer. As used herein, “lower layer” shall mean the layer closer to a surface or substrate, and “top layer” shall mean the layer disposed furthest away from the surface or substrate, such as a ship's hull. The marine laminate is also typically applied to a marine surface, such as a ship's hull, in a dry environment such as a dry dock. After assembling the marine laminate, the adhesive layer of the laminate is affixed to the dry marine surface. Once the adhesive portion of the marine laminate has fully cured on the marine surface, a marine vessel containing the affixed marine laminate is submerged underwater. The top layer includes coatings having anti-fouling, anti-corrosion, anti-drag, and anti-detection functions that respectively inhibit or prevent infestation by fouling organisms, inhibit or prevent corrosion, limit friction effects, or provide stealth properties for vessels or other marine structures. One disadvantage of such a marine laminate, therefore is a significant commercial expense associated with lost operation of the marine vessel and dry docking of the marine vessel required to affix the marine laminate on a dry marine surface.

Accordingly, there is a need for a marine flexible laminate system that includes an adhesive layer operable to adhere the marine flexible laminate system to a marine surface while the surface is submerged underwater. Furthermore, there is a need for a marine flexible laminate system that includes a primered backing layer operable to receive a functional top coat by application of the system to a surface submerged underwater.

### SUMMARY OF INVENTION

Accordingly, one embodiment of the present invention provides a marine flexible laminate system comprising:

an adhesive layer and a primer layer; wherein the primer layer is disposed on one side of the adhesive layer and the opposite side of the adhesive layer of the marine flexible laminate is operable to adhere to a surface disposed underwater.

According to another embodiment, the present invention also provides a marine flexible laminate system comprising:

an adhesive layer;

a primer layer; and

a backing layer, wherein the primer layer is disposed on one side of the backing layer and the adhesive layer is disposed on the opposite side of the backing layer, and wherein the adhesive layer comprises an adhesive operable to adhere the marine flexible laminate to a surface disposed underwater.

According to another embodiment, the present invention also provides a marine flexible laminate system comprising:

a functional top coat layer;

an adhesive layer;

a primer layer; and

a backing layer, wherein the primer layer is disposed on one side of the backing layer and the adhesive layer is disposed on the opposite side of the backing layer, and wherein the adhesive layer comprises an adhesive operable to adhere the marine flexible laminate to a surface disposed underwater.

According to another embodiment, the present invention also provides a marine flexible laminate system further comprising at least one functional top coating selected from the group consisting of: antifouling coatings, anti-drag coatings, anti-corrosion coatings, anti-detection coatings and combinations. According to an embodiment of the invention, the at least one functional top coating is operable to be applied to the exposed surface of the primer layer while underwater. According to a separate embodiment, the functional top coating is operable to be applied to the primer layer prior to submersing the marine flexible laminate underwater and applying the laminate to a surface disposed underwater.

According to another embodiment, the present invention also provides a marine flexible laminate system, wherein the primer layer comprises a reaction product formed by curing a coating composition selected from the group consisting of: epoxies, polyureas, polyurethanes, cyanoacrylates, polyesters, and blends thereof.

According to another embodiment, the present invention also provides a method for applying a marine flexible laminate system to a surface submerged underwater comprising the steps of:
(a) providing a marine flexible laminate comprising an adhesive layer and a primer layer disposed on one side of the adhesive layer;
(b) applying the marine flexible laminate to a surface disposed underwater by contacting an opposite side of the adhesive layer with the surface while the surface is underwater; and
(c) applying a functional top coating onto the exposed surface of the primer layer while the primer layer is underwater.

According to a separate embodiment, the invention also provides a method for applying a marine flexible laminate system to a surface submerged underwater comprising the steps of:
(a) providing a marine flexible laminate comprising an adhesive layer, a primer layer having a first side disposed on one side of the adhesive layer, and a functional top coating disposed on a second side, opposite the first side, of the primer layer; and
(b) applying the adhesive layer of the marine flexible laminate to a surface disposed underwater by contacting an opposite side of the adhesive layer with the surface while the surface is underwater.

According to a separate embodiment, the present invention also provides a method for applying a marine flexible laminate system to a surface submerged underwater comprising the steps of:
(a) providing a marine flexible laminate comprising an adhesive layer, a primer layer and a backing layer disposed between the adhesive layer and the primer layer, wherein the primer layer has a first side disposed on one side of the backing layer and the adhesive layer has a first side disposed on the other side of the backing layer;
(b) applying the marine flexible laminate to a surface disposed underwater by contacting a second side of the adhesive layer, opposite the first side of the adhesive layer, with the surface while the surface is underwater; and
(c) applying a functional top coating onto a second side of the primer layer, opposite the first side of the primer layer, while the primer layer is disposed underwater.

According to a separate embodiment, the present invention also provides a method for applying a marine flexible laminate system to a surface submerged underwater comprising the steps of:
(a) providing a marine flexible laminate comprising an adhesive layer, a primer layer, a backing layer disposed between the adhesive layer and the primer layer, and a functional top coating, wherein the primer layer has a first side disposed on one side of the backing layer and the adhesive layer has a first side disposed on the other side of the backing layer and the functional top coating is disposed on a second side of the primer layer, opposite the first side of the primer layer; and
(b) applying the marine flexible laminate to a surface disposed underwater by contacting a second side of the adhesive layer, opposite the first side of the adhesive layer, with the surface while the surface is underwater.

According to a separate embodiment, the present invention also provides a method for manufacturing a marine flexible laminate system comprising the steps of:
(a) disposing a primer layer on one side of a backing layer;
(b) disposing a first side of an adhesive layer on an opposite side of the backing layer, wherein adhesive layer comprises an adhesive operable to adhere to a surface disposed underwater;
(c) contacting a second side of the adhesive layer, opposite the first side, to a release layer.

According to a separate embodiment, the present invention also provides a method for manufacturing a marine flexible laminate system comprising the steps of:
(a) disposing a primer layer on one side of a backing layer;
(b) disposing a first side of an adhesive layer on an opposite side of the backing layer, wherein adhesive layer comprises an adhesive operable to adhere to a surface disposed underwater;
(c) contacting a second side of the adhesive layer, opposite the first side, to a release layer; and
(d) disposing at least one functional top coating onto the primer layer.

Other aspects of this invention will become apparent from the following detailed description of the invention and the appended claims.

### DETAILED DESCRIPTION OF INVENTION

Accordingly, the marine flexible laminate system of the present is applied to a surface or surfaces, including but not limited to marine surfaces for example, submerged underwater. The functional top coating is applied to a primer layer of the marine flexible laminate. According to one embodiment of this invention, the functional top coating is applied to the exposed surface of the primer layer after the primer layer is submerged underwater. The “exposed surface” of the primer layer means that surface (or side) which is not in contact with another layer but instead is in contact with water when the laminate is submersed. According to a separate embodiment, the functional top coating is incorporated earlier (i.e., before submersing) as part of a marine flexible laminate system, and the adhesive layer of this marine flexible laminate system is contacted with the marine surface underwater.

The adhesive used in accordance with the marine flexible laminate system comprises any suitable liquid, solution or compound with adhesive properties. Suitable adhesives include, but are not limited to for example, rubber-based adhesives, resin adhesives, wax-based adhesives, inorganic adhesives, structural adhesives, cured adhesives, pressure sensitive adhesives or any other adhesive compounds suitable for use underwater. For example, the structural adhesive may be of any curing type, such as aerobic-setting, anaerobic-setting, radiation-setting, thermal-setting, and water-setting. Furthermore, the structural adhesives may include, but are not limited to epoxies, polyureas, polyurethanes, cyanoacrylates, and polyesters.

According to one embodiment of this invention, both the primer layer disposed below the top coat and above the backing layer of the marine flexible laminate and the adhesive layer disposed on the opposite side of the backing layer may be reaction products formed by curing a coating composition chemically compatible with the top coat including but not limited to epoxies, polyureas, polyurethanes, cyanoacrylates, polyesters, or blends thereof.

In a separate embodiment of this invention, a pressure sensitive adhesive, such as but not limited to acrylic-based adhesives, rubber-based adhesives and the like may be combined with a thermally curable adhesive within the adhesive layer to provide both the necessary initial tack and bonding of the marine flexible laminate system to a marine surface submerged underwater.

Suitable epoxy adhesive resins which may be used in accordance with certain aspects of this invention, including but not limited to the adhesive layer and the primer layer, are characterized by having a molecular weight of about 800 to about 4,000, and a softening point of about 60° C. to about 160° C. and an epoxy equivalent weight of about 400 to 3,000. Representative examples of epoxy resins which may be used include without limitation Epikote™ 11001, 1004, 1007, and 1009 (produced by Hexion Specialty Chemicals, Inc.). At normal ambient temperatures these epoxy adhesives have a low stickiness to the touch and thus are poorly bonded to an object, but upon heating for a short time at a relatively low temperature of at about 50° C. or above, will exhibit excellent bond strength since the adhesive reacts on heating and is activated to have a viscosity such that the adhesive exhibits sufficient wetting to even a substrate whose surface is not smooth. The Epikote™ M epoxy resins may require cross-linker additives, such as but not limited to those generally well known in the art, to cure into a solid state with the required bond strength.

According to other embodiments, a heat generating layer may be present in the marine flexible substrate system. A heat generating layer may include a resistance heating material disposed between a non-primered side of a backing layer and a thermally curable adhesive layer.

According to another embodiment, the resistance heating material may be an electro-thermic layer coated onto the non-primered side of the backing layer. The electro-thermic layer may be applied to the backing layer using any suitable technique. The layer may be coated using extrusion or curtain coating methods. The electro-thermic film typically contains electroconductive carbon black particles or fibers dispersed in a suitable hydrophobic resin binder.

According to yet another embodiment, low resistance electrical leads which extend across the width of the resistance heating material, and a power supply (e.g., a battery) can be used to provide electrical energy to raise the temperature of the resistance heating material, and consequently the temperature of the backing layer and the thermally curable adhesive layer. Typically, thermally curable adhesives, including but not limited to epoxies, will remain uncured indefinitely until the temperature reaches at least about 50° C.

According to a separate embodiment, one method of manufacturing the heat generating layer, includes continuously laying heating elements (e.g., conductive wires) onto the non-primered side of the backing layer of a moving marine flexible laminate system (e.g. a moving roll of flexible substrate), while a molten film or coating layer of the adhesive is applied using either extrusion, curtain coating or any suitable method.

According to a separate embodiment, a release liner is included in the marine flexible laminate system. A suitable example of such a release liner is one that is generally coated with a thin layer of silicone release coating to separate and protect the adhesive layer. The release liner may be inserted adjacent to the exposed adhesive layer of the moving marine flexible laminate system before the flexible laminate is wound into a roll. The marine flexible laminate system as a product is manufactured for example as roll goods to the end user desiring to protect a marine surface from fouling, corrosion, drag, detection or the like by applying the flexible laminate to a marine surface submerged underwater. The product may also be provided in other forms such as sheets, panels, etc.

According to a separate embodiment, the adhesive may be a two component adhesive such as epoxy-polyamide (epoxy), isocyanate-amine (polyurea), isocyanate-polyol (polyurethane) and polyol-acid (polyester). The two component adhesive may also be an epoxy-polyamide (epoxy) or an isocyanate-polyol (polyurethane).

According to a separate embodiment, a pressure sensitive adhesive, including but not limited to acrylic-based adhesives, rubber-based adhesives and the like may be combined with a thermally curable adhesive within the adhesive layer to provide the necessary initial tack and permanent bonding of the marine flexible laminate system to a marine surface submerged underwater.

According to one embodiment, the marine flexible laminate is a applied to a marine surface submerged underwater by peeling the release layer off the composite and the exposing surface of the pressure sensitive adhesive containing adhesive layer is pressed onto the marine surface submerged underwater and adheres temporarily to the surface. A battery or other power source can be used to heat up the resistive material and the thermally-curable adhesive containing adhesive layer to the desired temperature to complete the cure and bond the marine flexible substrate system to the submerged marine surface.

The backing layer of the marine flexible laminate system may include a backing materials such as cellulose, plastic, fabric, wovens and non-wovens and the like for supporting the adhesive layer and the functional topcoat. Suitable examples of backing materials include woven fabrics, spun-bond non-woven fabrics, spun-melt non-woven fabrics, spun-lace non-woven fabrics, carded non-woven fabrics, cotton, rayon and fiberglass. Non-woven fabrics are a collection of individual fibers and therefore require some consolidation technique, such as thermal or adhesive bonding, to form a web.

According to one embodiment of this invention, the non-woven fabric backing material is selected from the group consisting of: polyamide, polyester, polyvinylhalide and blends thereof. These polymers have a crystalline structure which provides one or more properties such as moisture, chemical and temperature resistance, as well as mechanical strength. Furthermore, the non-woven webs provide improved coating adhesion and resistance to impact which may be attributed to the porous substrates allowing the liquid primer coating to saturate the web and harden when cured to form a strong bond, as illustrated in Example 3.

Representative examples of polyester non-woven webs which may be used in this invention include but are not limited to, Versa 70125X and 70160X (produced by Elk Corporation) having a basis weight of about 73 and about 93 gsm, respectively, and spun-bonded polyester non-woven (supplied by Circle Graphics and produced by Foshan Nanhai Jinlong Non-woven Co.) having a basis weight of about 87 and about 100 gsm. In another embodiment of the invention, the polyester non-woven web may have a weight of about 25 to about 300 gsm, and more particularly about 50 to about 150 gsm.

The primer layer of the marine flexible laminate system includes compositions such as epoxy-polyamide (epoxies), isocyanate-amine (polyureas), isocyanate-polyol (polyurethanes), acrylate copolymer (cyanoacrylates) and polyol-acid (polyesters). The primer composition may be an epoxy-polyamide (epoxies) or an isocyanate-polyol (polyurethanes). In one embodiment of the invention, the primer layer may be a reaction product formed by curing a coating composition including at least one modified epoxy resin, at least one hardening agent, and a reaction accelerating agent.

According to one embodiment, the cured primer layer which includes cured epoxy compositions provides a receptive surface for the wetting of typical antifouling paints. A receptive surface for wetting may be characterized by having a higher surface tension than the antifouling paint. Furthermore, hydrogen and covalent bonding may occur at the interface due to the chemical similarities (e.g., both epoxies) of the primer and the antifouling paint binder resulting in improved adhesion. Antifouling paint compositions of the functional top coating in the marine flexible laminate system typically include a solvent, such as xylene and have an average surface tension of about 30 dynes/cm. Primer layer materials, such as polyester and epoxide resins typically have average surface tension of about 40 and 50 dynes/cm, respectively.

Functional top coatings of the marine flexible laminate system have certain functionalities, including but not limited to for example, anti-fouling coatings, anti-drag coatings, anti-corrosion coatings, anti-detection coatings and combinations thereof. The functional top coatings may be applied to a receptive marine surface submerged underwater or may be included in a marine flexible laminate system. The functional top coatings are applied to the primered side of the backing layer or the primered side of the adhesive layer, depending on the flexible laminate system employed. The chemical compositions for these top coatings are well known in the art. For example, top coatings having silicone or fluoropolymer moieties may be useful for providing anti-drag functionality. A representative example of an anti-corrosion coating useful with this invention includes BIO-DUR® 560 (supplied by Thin Film Technology, Inc.). BIO-DUR® 560 is based on a blend of liquid epoxy polymer and aliphatic polyamine hardening agents and may be applied and cured underwater. BIO-DUR® 560 further contains Kevlar fibers, which are incorporated for reinforcement and viscosity management to achieve high application rates even underwater. BIO-DUR® 560 is considered 100% solids and may be applied by a variety of methods including but not limited to brushing, rolling, or spraying.

According to a separate embodiment of this invention, the primer layer comprises the reaction product of a thermal curable, radiation curable, oxidative curable or microwave curable epoxy coating composition containing at least one modified epoxy resin; at least one amine hardening agent; and a reaction accelerating agent.

Furthermore, other non-amine moieties such as, but not limited to urethanes, acrylics, alcohols, fatty amides and phenols can react with the epoxy moiety while the coating is submerged underwater.

The primer layer also protects the non-woven layer from water damage, and can improve strength for the non-woven layer. Furthermore, the primer layer may provide resistance to penetration of the non-woven layer by the antifouling paint resin binder, thereby avoiding the problem of the biocide lacking sufficient binder to remain adhered to the primer layer.

According to one embodiment, the primer coating composition comprises about 50 to about 80 parts by weight of the modified epoxy resin, about 20 to about 40 parts by weight of the hardening agent, and about 1 to about 5 parts by weight of the accelerating agent based upon the total weight of the primer coating composition.

According to a separate embodiment, the coat weight of the primer layer may be any quantity which provides full coverage of the fibers of the non-woven web, and in particular about 20 gsm to about 300 gsm, and more particularly about 50 gsm to about 200 gsm for a 100 gsm spun-bonded polyester non-woven. Substantially any application method for applying coatings to non-wovens may be useful in this invention including roll coating, slot coating, spray coating, brush coating, screening, gravure coating and combinations of coating methods.

The lower molecular weight epoxies are generally liquid at room temperature, therefore other wetting agents, such as but not limited to solvents may not be required within the formulation. Typically, the modified epoxy resins useful for this invention will have an epoxide equivalent weight from about 150 to about 10,000, and in particular about 150 to about 3,000, and more particularly about 1,500 to about 2,500. Representative examples of modified epoxy resins include but are not limited to ether-type epoxies, ester-type epoxies, acrylic-modified epoxies, phenolic-modified epoxies and urethane-modified epoxies.

The ether type epoxy resins (e.g., diglycidyl ether of bisphenol A), may provide hardness, and strength to the cured coating composition. Representative examples of DGEBA epoxy resins include ARALDITE GY-6004 (supplied by Vantico, Inc.) as illustrated in Example 2 and 3. In one embodiment, the Araldite GY-6004 is incorporated into the coating composition in the amount of about 10 to 40 parts by weight, and more particularly in an amount of about 15 to 30 parts by weight. The ester-type epoxy resins (e.g., polyglycidyl esters) may be used as modifiers to provide increased flexibility, some hydrophilicity, and improved impact resistance in the cured coating composition. For more flexible coatings, a polyol based resin is included in the cured coating composition. Representative examples include ARALDITE GY-508 (supplied by Vantico, Inc.) as illustrated in Example 2 and 3. In one embodiment, the Araldite GY-508 is incorporated into the primer coating composition in the amount of about 30 to 60 parts by weight, and more particularly in an amount of about 35 to 50 parts by weight.

The hardening agent is selected from the group consisting of aliphatic amines, imidazoline polyamides, cycloaliphatic amines, phenolic resins, anhydrides, carboxylic acids, and blends thereof.

According to one embodiment, a fatty acid modified aliphatic diamine may be useful as an underwater hardener for DGEBA type epoxy resins. Representative examples include SURWET R (supplied by Air Products and Chemicals, Inc.) as illustrated in Example 2 and 3. SURWET R has a high molecular weights and includes hydrophobic components has an amine value of about 225 to about 400 mg KOH/gram, and may be incorporated into the primer coating composition in the amount of about 10 to 30 parts by weight, and more particularly in an amount of about 10 to 20 parts by weight.

According to a separate embodiment, cycloaliphatic amines may be useful as an underwater hardener for DGEBA type epoxy resins. Representative examples include ANCAMINE® MCA (marketed by Air Products and Chemicals, Inc.) as illustrated in Example 2 and 3. ANCAMINE® MCA includes a low molecular weight mixture of cycloaliphatic amine (e.g., 3-Aminomethyl-3,5,5 trimethylcyclohexylamine), aromatic alcohol, and phenol, and is an effective wetting agent, as it easily displaces the adsorbed water at the substrate, and allows the coating to spread readily onto the substrate and improve the epoxy system's brush-ability. ANCAMINE® MCA may be incorporated into the primer coating composition in the amount of about 5 to 18 parts by weight, and more particularly in an amount of about 10 to 18 parts by weight. However, the content of the ANCAMINE® MCA should not exceed 20 parts by weight to avoid problems with excessive hydrophilicity which deteriorates the ability to cure underwater.

According to a separate embodiment, SUR WET R may be co-cured with a minor proportion of ANCAMINE® MCA to provide the necessary hydrophobic and wetting performance at the substrate interface as illustrated in Example 2 and 3.

According to some embodiments, such as those that involve adhesives having curing temperatures below 60° C., an accelerating agent such as a tertiary amine or a aliphatic amine may provide a faster cure rate when used in combination with other hardening agents such as ANCAMINE® MCA, SURWET R, and blends thereof. Representative examples include ANCAMINE® K-54 (marketed by Air Products and Chemicals, Inc.) as illustrated in Example 2 and 3. ANCAMINE® K-54 has an amine value of about 600 to about 900 mg KOH/gram, and may be incorporated into the primer coating composition in the amount of about 0.05 to 10 parts by weight, and more particularly in an amount of about 1 to 5 parts by weight.

According to some embodiments, it is desirable to add a rheological control agent to thicken the consistency of the primer coating composition to make the applied coat weight more uniform. Rheological control agents are well known in the art. A representative example includes CAB-O-SIL® TS-720 (marketed by Cabot Corporation), a fumed silica thixotrope. As illustrated in Example 2 and 3, CAB-O-SIL® TS-720 may be incorporated into the primer coating composition in the amount of about 0.05 to 10 parts by weight, and more particularly in an amount of about 1 to 5 parts by weight based upon the total weight of said coating composition.

According to one embodiment, a marine functional flexible laminate system includes a functional top coat wherein the functional top coat may be an antifouling paint. U.S. Pat. No. 6,555,228 to Guritza discloses particularly useful antifouling compound compositions which are further described in Example 1 of the present invention. In the '228 patent first example “A stenoprophiluric media is prepared by separating an amount of epoxy resin available commercially as Araldite 508 into two portions. The first portion (Part A) comprises a quarter of the total resin. To Part A is added a 1.5 stoichiometric excess of triethylenetetraamine (TETA) portionwise to avoid excessive exothermic temperature increase. To the other portion of the resin is added copper powder having a cuboidal shape and having a surface area of 0.18 m2/g, a bulk density of 3.2 g/ml and an average particle size of 29 microns, and Araldite 6004 (poly-glycidal blend for flexibility and hydrophilicity). The copper is added at an amount to have 55% copper in the resulting mixture. The amount of Araldite 6004 is 0.43 parts for each part of Araldite 508 in Part B. The admix ratio of the media is 1 part of Part A to 4 parts of Part B. Parts A and B are combined and then are applied to a substrate such as a boat hull. The above bio-supportive media is employed by adding the media to a boat hull with appropriate base adhesion coat and mid-coat for corrosion and insulation barriers to bimetallic galvanic actions, to prevent adherence of barnacles and other undesirable organisms.” Furthermore, in the '228 patent second example “A stenoprophiluric media is prepared by mixing 4 parts of a mixture prepared from a mixture of 292 parts of Araldite GY 508 and 199 parts of TERA and one part of a mixture of 870 parts of Araldite 508, 499 parts of Araldite 6004 and 1993 parts of the copper power of the first example.”

Moisture curable polyurethane resins containing excess isocyanate groups can further react and cross-link with moisture. The reaction product of an isocyanate group and water is an amine moiety which can further react with another isocyanate group to form a urea moiety. Moisture curable polyurethane resins useful in this invention are characterized by having a molecular weight of about 400 (minimum). In the dry state these polyurethane adhesives have a low stickiness to the touch and thus are poorly bonded to an object, but upon sufficient hydration the polyurethane adhesive will exhibit excellent bond strength in a short period of time. The two part polyurethane adhesive reacts with moisture and is thus activated to have a viscosity such that the adhesive exhibits sufficient wetting to even a substrate whose surface is not smooth. Alternative moisture curable adhesives include but are not limited to cyanoacrylates and silicones.

According to a separate embodiment, a pressure sensitive adhesive, including but not limited to acrylic-based adhesives, rubber-based adhesives and the like may be combined with a moisture curable adhesive within the adhesive layer to provide the necessary initial tack and permanent bonding of the marine flexible substrate system to marine surfaces submerged underwater.

A heat generating layer and associated power source are not required with the moisture-cured polyurethane adhesive. However, a release liner that is generally coated with a thin layer of silicone release coating may be inserted adjacent to the exposed polyurethane adhesive layer of the moving marine flexible substrate system before the composite is wound into a roll. The release liner may be made of polyester material, polyolefin material, kraft paper material or the like. During underwater application, the release layer is peeled off the composite, and the exposed surface of the un-cured polyurethane adhesive is quickly pressed onto the underwater substrate thus facilitating the bond between the marine flexible substrate system and the underwater surface.

The following examples are non-limiting and provide further illustrations of the present invention.

### EXAMPLE 1

An antifouling copper epoxy composition was prepared based upon the formulations disclosed in U.S. Pat. No. 6,555,228 to Guritza as Examples 1 and 2. The antifouling composition was prepared for use as a control by mixing Part A from a mixture of 292 parts of Araldite GY-508 and 199 parts of TETA; and by mixing Part B from a mixture of 870 parts of Araldite GY-508, 499 parts of Araldite GY-6004, and 1993 parts of copper powder. The final antifouling copper epoxy coating (1 Part A to 4 Parts B) composition was mixed by hand thoroughly and let stand for about 3 minutes prior to coating to ensure that no separation occurred. Viscosities of the mixture were high, but no addition of solvent was necessary. This composition failed to adhere when brushed onto the wood and concrete surfaces submerged under water in an aluminum pan. This composition quickly dispersed into chunks and clouded the water. The triethylene tetramine (TETA supplied by the Dow Chemical Company) is a low molecular weight amine that is water soluble, which is believed to be the primary cause of the failure of this coating composition in underwater applications.

### EXAMPLE 2

An epoxy primer composition was prepared by mixing Part A prepared from a mixture of 25 parts of Sur-Wet R, 23 parts of Ancamine MCA, 4 parts of Ancamine K-54 and 2 parts of Cab-O—Sil TS-720; with Part B prepared from a mixture of 70 parts of Araldite GY-508, 30 parts of Araldite GY-6004, and 2 parts of Cab-O—Sil TS-720. The final epoxy primer coating (1 Part A to 1 Part B) composition was mixed thoroughly and brushed onto metal and wood surfaces submerged under water in an aluminum pan. This mixture was very effective as the coating displaced the water from the substrate surfaces and wetted those surfaces quickly. The coated substrates remained submerged underwater for 24 hours, and the water in the aluminum pan remained clear and the cured coating surface showed no defects.

### EXAMPLE 3

The epoxy primer composition of Example 2 was applied to an 87 gsm spun bonded polyester non-woven (supplied by Circle Graphics) substrate in an effort to saturate or prime the substrate prior to applying the antifouling coating formulation detailed in Example 1. The screening process was utilized as the coating method for applying the epoxy primer onto the non-woven substrate. The screening process utilized a 110 mesh screen and a squeegee to force the coating through open portions of the mesh onto the substrate. Screening of the epoxy coating had to be carried out within 30 minutes after Parts A and B were mixed, due to the increase in viscosity. Non-permanent spray-on glue was used to hold the substrate in place, preventing it from sticking to the screen after being coated. The coated layer was cured in an oven at 105° C. for 5 minutes. The coating application weight of the saturant was about 200 gsm. The saturated polyester non-woven showed excellent flexibility and toughness and was glued under water to a steel panel with an epoxy adhesive, BIO-DUR 560 (supplied by Thin Film Technology, Inc.) which is specifically formulated for underwater applications. This marine laminate showed no signs of failure after being immersed in water for more than 2 weeks.

What is claimed is:

1. A marine flexible laminate system comprising:
an adhesive layer;
a primer layer; and
a backing layer, wherein the primer layer is disposed on one side of the backing layer and the adhesive layer is disposed on the opposite side of the backing layer, and wherein the adhesive layer comprises an adhesive operable to adhere to a surface disposed underwater.

2. The marine flexible laminate system of claim 1 further comprising at least one functional top coating selected from the group consisting of: antifouling coatings, anti-drag coatings, anti-corrosion coatings, anti-detection coatings and combinations thereof.

3. The marine flexible laminate system of claim 1 wherein the backing layer comprises a fabric layer selected from the group consisting of: woven fabrics, spun-melt non-woven fabrics, spun-bond non-woven fabrics, spun-lace non-woven fabrics and carded non-woven fabrics.

4. The marine flexible laminate system of claim 1 wherein the backing layer comprises a non-woven fabric is selected from the group consisting of: polyamides, polyesters, polyvinylhalides, cotton, rayon, fiberglass and blends thereof.

5. The marine flexible laminate system of claim 4 wherein the amount of non-woven fabric layer is between about 50 and about 150 grams per square meter, based on the weight of the flexible marine substrate.

6. The marine flexible laminate system of claim 1 wherein the primer layer comprises a reaction product formed by curing a coating composition selected from the group consisting of: epoxies, polyureas, polyurethanes, cyanoacrylates, polyesters, and blends thereof.

7. The marine flexible laminate system of claim 6 wherein the coating composition of the primer layer is a thermal curable coating composition further comprising:
a) at least one modified epoxy resin;
b) at least one hardening agent; and
c) a reaction accelerating agent.

8. The marine flexible laminate system of claim 7 wherein the at least one modified epoxy resin is selected from the group consisting of: ether-type epoxies, ester-type epoxies, acrylic-modified epoxies, phenolic-modified epoxies, urethane-modified epoxies and combinations thereof.

9. The marine flexible laminate system of claim 7 wherein the at least one hardening agent is selected from the group consisting of: aliphatic amines, imidazoline polyamides, cycloaliphatic amines, phenolic resins, anhydrides, carboxylic acids and blends thereof.

10. The marine flexible laminate system of claim 7 wherein the accelerating agent is selected from the group consisting of: tertiary amines and aliphatic amines.

11. The marine flexible laminate system of claim 7, wherein the coating composition of the primer layer comprises about 50 to about 80 parts by weight of the at least one modified epoxy resin, about 20 to about 40 parts by weight of the at least one hardening agent, and about 1 to about 5 parts by weight of the accelerating agent, based on the total weight of said coating composition.

12. The marine flexible laminate system of claim 11 wherein the coating composition of the primer layer further comprises a viscosity thickening agent.

13. The marine flexible laminate system of claim 12 wherein said thickening agent is a fumed silica thixotrope and is reacted in an amount from about 0.05 to about 1 parts by weight, based upon the total weight of said coating composition.

14. The marine flexible laminate system of claim 1 wherein the coat weight of the primer layer is between about 150 and about 300 grams per square meter, based on the weight of the marine flexible substrate.

15. The marine flexible laminate system of claim 1 wherein the adhesive layer comprises an adhesive selected from the group consisting of: epoxy-polyamide (epoxy), isocyanate-amine (polyurea), isocyanate-polol (polyurethane), polyol-acid (polyester), acrylic-based, rubber-based and blends thereof.

16. The marine flexible laminate system of claim 1 wherein the adhesive layer further comprises an acrylic-based pressure sensitive adhesive blended with a thermally curable epoxy adhesive.

17. The marine flexible substrate system of claim 1 wherein the adhesive layer comprises an acrylic-based pressure sensitive adhesive blended with a moisture curable polyurethane adhesive.

18. The marine flexible substrate system of claim 1 wherein said adhesive layer further comprises a heat generating layer and a release liner.

19. A marine flexible laminate system comprising:
an adhesive layer and a primer layer; wherein the primer layer is disposed on one side of the adhesive layer and the opposite side of the adhesive layer of the marine flexible laminate is operable to adhere to a surface disposed underwater.

20. A method for applying a marine flexible laminate system to a surface submerged underwater comprising the steps of:
(a) providing a marine flexible laminate comprising an adhesive layer and a primer layer disposed on one side of the adhesive layer;
(b) applying the marine flexible laminate to a surface disposed underwater by contacting an opposite side of the adhesive layer with the surface while the surface is underwater; and
(c) applying a functional top coating onto the exposed surface of the primer layer while the primer layer is underwater.

21. A method for applying a marine flexible laminate system to a surface submerged underwater comprising the steps of:
(a) providing a marine flexible laminate comprising an adhesive layer, a primer layer having a first side disposed on one side of the adhesive layer, and a functional top coating disposed on a second side, opposite the first side, of the primer layer; and
(b) applying the adhesive layer of the marine flexible laminate to a surface disposed underwater by contacting an opposite side of the adhesive layer with the surface while the surface is underwater.

22. A method for applying a marine flexible laminate system to a surface submerged underwater comprising the steps of:
(a) providing a marine flexible laminate comprising an adhesive layer, a primer layer and a backing layer disposed between the adhesive layer and the primer layer, wherein the primer layer has a first side disposed on one side of the backing layer and the adhesive layer has a first side disposed on the other side of the backing layer;
(b) applying the marine flexible laminate to a surface disposed underwater by contacting a second side of the adhesive layer, opposite the first side of the adhesive layer, with the surface while the surface is underwater; and
(c) applying a functional top coating onto a second side of the primer layer, opposite the first side of the primer layer, while the primer layer is disposed underwater.

23. A method for applying a marine flexible laminate system to a surface submerged underwater comprising the steps of:
(a) providing a marine flexible laminate comprising an adhesive layer, a primer layer, a backing layer disposed between the adhesive layer and the primer layer, and a functional top coating, wherein the primer layer has a first side disposed on one side of the backing layer and the adhesive layer has a first side disposed on the other side of the backing layer and the functional top coating is disposed on a second side of the primer layer, opposite the first side of the primer layer; and
(b) applying the marine flexible laminate to a surface disposed underwater by contacting a second side of the adhesive layer, opposite the first side of the adhesive layer, with the surface while the surface is underwater.

24. A method for manufacturing a marine flexible laminate system comprising the steps of:
(a) disposing a primer layer on one side of a backing layer;
(b) disposing a first side of an adhesive layer on an opposite side of the backing layer, wherein adhesive layer comprises an adhesive operable to adhere to a surface disposed underwater;
(c) contacting a second side of the adhesive layer, opposite the first side, to a release layer.

25. A method for manufacturing a marine flexible laminate system comprising the steps of:
(a) disposing a primer layer on one side of a backing layer;
(b) disposing a first side of an adhesive layer on an opposite side of the backing layer, wherein adhesive layer comprises an adhesive operable to adhere to a surface disposed underwater;
(c) contacting a second side of the adhesive layer, opposite the first side, to a release layer; and
(d) disposing at least one functional top coating onto the primer layer.
